(19) United States
(12) Patent Application Publication
(10) Pub. No.: US 2025/0339846 A1
(43) Pub. Date: Nov. 6, 2025

(54) METHOD TO IMPROVE SORBENT LIFETIME FOR DIRECT AIR CAPTURE

(71) Applicant: Triad National Security, LLC, Los Alamos, NM (US)

(72) Inventors: Harshul Thakkar, Los Alamos, NM (US); Rajinder Singh, Los Alamos, NM (US)

(21) Appl. No.: 18/654,945

(22) Filed: May 3, 2024

(51) Int. Cl. B01J 20/34; B01D 53/04; B01J 20/26

(52) U.S. Cl. CPC B01J 20/3458; B01D 53/0454; B01J 20/26; B01J 20/3425; B01D 2253/202; B01D 2257/504

(57) ABSTRACT

Methods of improving sorbent lifetime when performing direct air capture (DAC) of carbon dioxide from carbon dioxide-containing gas mixtures are described. The methods use ammonia gas to regenerate sorbent and release carbon dioxide from the sorbent. These methods prevent degradation and erosion of the sorbent, extending lifetimes of DAC systems, greatly reducing operating cost and making these systems more economically feasible.

### STATEMENT REGARDING FEDERAL RIGHTS

LANL is operated by Triad National Security, LLC for the National Nuclear Security Administration under contract 89233218CNA000001. The government has certain rights in the invention.

### BACKGROUND

Carbon dioxide (CO2) levels in the atmosphere have been steadily rising for decades, and make up a majority of greenhouse gas emissions. These greenhouse gases play a major role in worsening climate change. Accordingly, efforts to minimize rising global temperatures often involve ways to reduce CO₂ levels in the atmosphere.

One method of reducing atmospheric CO₂ levels is direct air capture (DAC) of CO₂. DAC is a two step process. The first step is to capture CO₂ from a gas mixture (such as atmosphere) using a sorbent material. The second step is to release the CO₂ from the sorbent material to produce a high-purity stream of CO₂ for geologic storage or other utilization.

Current DAC technologies employ two types of sorbents: liquid and solid. Liquid sorbents suffer from their high capital cost and energy consumption (>400 kJ of work/mole of CO₂). Amine-based solid adsorbents have shown great promise for DAC of CO₂ due to advantages such as high CO₂ adsorption capacity, relatively low regeneration temperature (120° C.) or energy requirement, and enhanced CO₂ uptake in the presence of water. However, oxidative and thermal degradation of amines at regeneration temperatures (ca. 120° C.) greatly hampers their durability. Oxidative and thermal degradation of the sorbent due to free radical formation by the reaction of oxygen with amines and evaporation of amines, respectively, occurs only at regeneration temperature (≥80° C.).

Techno-economic analysis of DAC suggests that the sorbent cost governs the overall cost for DAC. Therefore, reducing sorbent degradation for enhanced lifetime is critical for large scale DAC deployment. In addition, process innovation for energy-efficient adsorbent regeneration enabling the purified CO₂ separation together with long-term material stability is key to low-cost DAC. Accordingly, methods of improving sorbent lifetime by preventing thermo-oxidative degradation of the adsorbent would be beneficial.

It is in an effort to overcome the limitations of the above-described methods, and other limitations, that the present embodiments were designed.

### BRIEF SUMMARY

An embodiment is a method of removing carbon dioxide from a carbon dioxide-containing gas mixture, said method comprising:
i) contacting an amine-based or nitrogen-rich sorbent with said gas mixture, thereby causing the carbon dioxide to be adsorbed to a surface of said sorbent, forming a carbon dioxide/sorbent complex; and
ii) regenerating said sorbent by contacting said carbon dioxide/sorbent complex with ammonia gas, causing the sorbent to release said carbon dioxide.

### DETAILED DESCRIPTION AND DISCUSSION

Various embodiments now will be described more fully hereinafter in which some, but not all embodiments are shown. Indeed, various embodiments may be embodied in many different forms and should not be construed as limited to the embodiments set forth herein; rather, these embodiments are provided so that this disclosure will satisfy applicable legal requirements.

Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%- 9.9%, and 5.01%- 9.99%.

As used herein, “about” in the context of a numerical value or range means within ±10% of the numerical value or range recited or claimed.

An embodiment is a method of removing carbon dioxide from a carbon dioxide-containing gas mixture, said method comprising:
i) contacting an amine-based or nitrogen-rich sorbent with said gas mixture, thereby causing the carbon dioxide to be adsorbed to a surface of said sorbent, forming a carbon dioxide/sorbent complex; and
ii) regenerating said sorbent by contacting said carbon dioxide/sorbent complex with ammonia gas, causing the sorbent to release said carbon dioxide.

In an embodiment, step i) is performed at a temperature between −30 to 50° C. In an embodiment, step i) is performed at a temperature of at least, at most, or about −30, −25, −20, −15, −10, −5, 0, 5, 10, 15, 20, 25, 30, 35, 40, 45, or 50° C., or within a range defined by any two of these values.

In an embodiment, step i) is performed at ambient air pressure.

In an embodiment, the gas mixture in step i) initially comprises 10-1000 ppm carbon dioxide, prior to contact with the sorbent. In an embodiment, the gas mixture in step i) initially comprises at least, at most or about 10, 50, 100, 150, 200, 250, 300, 350, 400, 450, 500, 550, 600, 650, 700, 750, 800, 850, 900, 950, or 1000 ppm carbon dioxide, or within a range defined by any two of these values.

In an embodiment, step ii) is performed at a temperature of 75-120° C. In an embodiment, step ii) is performed at a temperature of 100-120° C. In an embodiment, step ii) is performed at a temperature of at least, at most, or about 75, 80, 85, 90, 95, 100, 105, 110, 115, or 120,° C., or within a range defined by any two of these values.

In an embodiment, step ii) is performed at a pressure of 20-600 mbar.

In an embodiment, the amine-based sorbent comprises an aminopolymer. In an embodiment, the aminopolymer is selected from the group consisting of polyethyleneimine (PEI), linear polyethyleneimine (LPEI), branched PEI (BPEI), polyallylamine, polyaniline, aminodendrimers, and polypropyleneimine.

In an embodiment, the amine-based sorbent comprises tetraethylenepentamine (TEPA), triethylenetetramine (TETA), diethylenetriamine (DETA), 3-aminopropyltrimethyoxysilane, or triamine (TRI).

In an embodiment, the amine-based sorbent is not integrated with a support.

In an embodiment, the amine-based sorbent is integrated with a support. In an embodiment, the support is an organic support. In an embodiment, the support is an inorganic support.

In an embodiment, the organic support is selected from the group consisting of graphite, graphene, vitreous carbon, silicon carbon, polymers, and any combination thereof. In an embodiment, the inorganic support is selected from the group consisting of silica compounds, alumina compounds, aluminosilicate compounds, metal, a titanium compound, oxides, ceramic compounds, and any combination thereof.

In an embodiment, the support is nitrogen-rich and/or comprises an N-functional group. In an embodiment, the N-functional group is selected from the group consisting of amides, amidines, amines, imines, imides, azides, cyanates, nitrates, nitriles, nitrites, nitro groups, nitroso groups, oximes, pyridine, or carbamate esters.

In embodiments, a nitrogen-rich support or sorbent comprises a material selected from an imidazole-based material, a pyridine-based material, and zwitterionic materials. In an embodiment, the imidazole-based material is polybenzimidazole. In an embodiment, the pyridine based material is 4-vinylpyridine.

In an embodiment, the sorbent is present within pores and/or bound to the surface of the support.

In an embodiment, the sorbent comprises an amine which is covalently or physically bound to the support.

In an embodiment, the sorbent exhibits a CO₂ loading of at least 0.1 mmol CO₂ per g of sorbent.

In an embodiment, steps i) and ii) are repeated in at least five cycles, and wherein the sorbent exhibits a CO₂ loading during the fifth cycle which is at least 50% of the CO₂ loading during the first cycle.

In an embodiment, the method further comprises iii) sequestering the released carbon dioxide.

As noted above, the first step of DAC is to capture CO₂ from a gas mixture (such as atmosphere) using a sorbent material. To accomplish this, a system suitable for causing the gas mixture to contact the sorbent is provided. Non-limiting examples of systems and methods for DAC are described in, for example, U.S. Pat. Nos. 9,227,153, 10,239,017 and 10,279,306; U.S. Pat. Pub. No. 2024/0075452; Fasihi et al., “Techno-economic assessment of CO₂ direct air capture plants,” J. Cleaner Production, 224:957-980 (2019); and An et al., “A comprehensive review on regeneration strategies for direct air captures,” J. CO₂ Utilization, 76:102587 (2023), each of which are incorporated by reference in their entirety. Often, the system comprises a chamber with a sorbent disposed therein. In an embodiment, the gas mixture temperature is 0-100° C. prior to contacting the sorbent. In an embodiment, the gas mixture is at ambient air pressure when contacting the sorbent. Atmospheric CO₂ is generally present at a concentration of approximately 420 ppm, by mass.

As also noted, the sorbent used in the instant invention is an amine-based or nitrogen-rich sorbent. Any such sorbent may be used in the methods. Amine-based sorbents include those described in U.S. Pat. Pub. No. 2024/0058783 and Duan et al., “Chemisorption and regeneration of amine-based CO₂ sorbents in direct air capture,” Materials Today Sustainability 23:100453 (2023), each of which is hereby incorporated by reference in its entirety. The amine-based sorbent may be any sorbent capable of binding CO₂ derivable from ammonia by replacement of one or more H groups. This includes primary, secondary, tertiary, and quaternary amines. In an embodiment, the sorbent is a primary amine. In an embodiment, the sorbent is a secondary amine. In an embodiment, the sorbent is a tertiary amine. In an embodiment, the sorbent is a quaternary amine.

In an embodiment, the sorbent is an aminopolymer. In an embodiment, the aminopolymer is selected from the group consisting of polyethyleneimine (PEI), linear polyethyleneimine (LPEI), branched PEI (BPEI), polyallylamine, polyaniline, aminodendrimers, and polypropyleneimine. The aminopolymer can also be a random or block copolymer prepared from monomers used to generate two or more of the above-listed aminopolymers.

In an embodiment, the amine-based solid sorbent comprises tetraethylenepentamine (TEPA), triethylenetetramine (TETA), diethylenetriamine (DETA), 3-aminopropyltrimethyoxysilane, or triamine (TRI).

In an embodiment, the sorbent is a mixture of one or more amine-based solid sorbents.

Often, the sorbent is integrated into some sort of solid support. Examples of supports and methods of integrating the sorbent into the supports are described in Duan et al. (2023). In an embodiment, the sorbent is impregnated into the support. In an embodiment, the sorbent is covalently bound to the support. This includes both smaller molecules and polymers, which can be polymerized in situ on the support, or polymerized elsewhere and then bound to the support. the support is selected from the group consisting of silica compounds, alumina compounds, aluminosilicate compounds, graphite, vitreous carbon, graphene, silicon carbon, metal, polymer, a titanium compound, oxides, cellulose, ceramic compounds, and any combination thereof. In an embodiment, the support is nanofibrillar cellulose.

In an embodiment, the sorbent is contacted with the gas mixture for a period of time ranging from 1 second to 60 minutes. In an embodiment, the period of time is at least, at most, or about 1 second, 10 seconds, 30 seconds, 1 minute, 2 minutes, 3 minutes, 4 minutes, 5 minutes, 6 minutes, 7 minutes, 8 minutes, 9 minutes, 10 minutes, 11 minutes, 12 minutes, 13 minutes, 14 minutes, 15 minutes, 16 minutes, 17 minutes, 18 minutes, 19 minutes, 20 minutes, 21 minutes, 22 minutes, 23 minutes, 24 minutes, 25 minutes, 26 minutes, 27 minutes, 28 minutes, 29 minutes, 30 minutes, 31 minutes, 32 minutes, 33 minutes, 34 minutes, 35 minutes, 36 minutes, 37 minutes, 38 minutes, 39 minutes, 40 minutes, 41 minutes, 42 minutes, 43 minutes, 44 minutes, 45 minutes, 46 minutes, 47 minutes, 48 minutes, 49 minutes, 50 minutes, 51 minutes, 52 minutes, 53 minutes, 54 minutes, 55 minutes, 56 minutes, 57 minutes, 58 minutes, 59 minutes, or 60 minutes, or within a range defined by any two of these values.

In an embodiment, the sorbent exhibits a CO₂ loading of at least 0.1 mmol CO₂ per g of sorbent. In an embodiment, the amine-based solid sorbent exhibits a CO₂ loading of at least 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8. 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, or 10.0 mmol CO₂ per g of amine-based solid sorbent.

In the second step, the gas mixture (now depleted of some carbon dioxide) is replaced by ammonia gas, which causes the sorbent to release carbon dioxide.

In an embodiment, the second step is performed at a temperature that is greater than the temperature used in the first step. In an embodiment, the first step and the second step are performed at the same temperature.

In an embodiment, the second step is performed at a pressure of 20-600 mbar.

The released carbon dioxide may then be removed. The sorbent is thereby regenerated, and capable of adsorbing carbon dioxide from a new carbon dioxide-containing gas mixture.

As noted above, the use of ammonia gas (rather than other gases such as nitrogen gas or steam) prevents degradation and erosion of sorbent. In an embodiment, the system (and, specifically, the sorbent) retains at least 50% of its CO₂ loading capacity in the final cycle, compared to the first cycle, when the first and second steps are repeated in at least 5 cycles. In an embodiment, at least 50%, at least 60%, at least 70%, at least 80%, at least 90%, at least 95%, at least 98%, or at least 99% of the CO₂ loading capacity is retained in the final cycle when the first and second steps are repeated in at least 5, 10, 15, 20, 25, 30, 35, 40, 45, 50, 75, 100, 150, 200, 250, 300, 350, 400, 450, or 500 cycles.

All of the references cited above, as well as all references cited herein, are incorporated herein by reference in their entireties.

While embodiments have been illustrated and described in detail above, such illustration and description are to be considered illustrative or exemplary and not restrictive. It will be understood that changes and modifications may be made by those of ordinary skill within the scope and spirit of the following claims. In particular, embodiments of the invention may include any combination of features from different embodiments described herein.

Many modifications and other embodiments will come to mind to one skilled in the art to which these embodiments pertain having the benefit of the teachings presented in the foregoing descriptions. Therefore, it is to be understood that the embodiments are not to be limited to the specific embodiments disclosed and that modifications and other embodiments are intended to be included within the scope of the appended claims and list of embodiments disclosed herein. Although specific terms are employed herein, they are used in a generic and descriptive sense only and not for purposes of limitation. For the embodiments described in this application, each embodiment disclosed herein is contemplated as being applicable to each of the other disclosed embodiments.

What is claimed is:

1. A method of removing carbon dioxide from a carbon dioxide-containing gas mixture, said method comprising:
i) contacting an amine-based or nitrogen-rich sorbent with said gas mixture, thereby causing the carbon dioxide to be adsorbed to a surface of said sorbent, forming a carbon dioxide/sorbent complex; and
ii) regenerating said sorbent by contacting said carbon dioxide/sorbent complex with ammonia gas, causing the sorbent to release said carbon dioxide.

2. The method of claim 1, wherein step i) is performed at a temperature between −30 to 50° C.

3. The method of claim 1, wherein step i) is performed at ambient air pressure.

4. The method of claim 1, wherein the gas mixture in step i) initially comprises 10-1000 ppm carbon dioxide by mass.

5. The method of claim 1, wherein step ii) is performed at a temperature of 75-120° C.

6. The method of claim 5, wherein step ii) is performed at a temperature of 100-120° C.

7. The method of claim 1, wherein step ii) is performed at a pressure of 20-600 mbar.

8. The method of claim 1, wherein the amine-based sorbent comprises an aminopolymer.

9. The method of claim 8, wherein the aminopolymer is selected from the group consisting of polyethyleneimine (PEI), linear polyethyleneimine (LPEI), branched PEI (BPEI), polyallylamine, polyaniline, aminodendrimers, and polypropyleneimine.

10. The method of claim 1, wherein the amine-based sorbent comprises tetraethylenepentamine (TEPA), triethylenetetramine (TETA), diethylenetriamine (DETA), 3-aminopropyltrimethyoxysilane, or triamine (TRI).

11. The method of claim 1, wherein the sorbent is not integrated with a support.

12. The method of claim 1, wherein the sorbent is integrated with a support.

13. The method of claim 12, wherein the support is an organic support.

14. The method of claim 12, wherein the support is an inorganic support.

15. The method of claim 12, wherein the support is nitrogen-rich and/or comprises an N-functional group.

16. The method of claim 12, wherein the sorbent is present within pores and/or bound to the surface of the support.

17. The method of claim 12, wherein the sorbent comprises an amine which is covalently or physically bound to the support.

18. The method of claim 1, wherein the sorbent exhibits a CO₂ loading of at least 0.1 mmol CO₂ per g of sorbent.

19. The method of claim 18, wherein steps i) and ii) are repeated in at least five cycles, and wherein the sorbent exhibits a CO₂ loading during the fifth cycle which is at least 50% of the CO₂ loading during the first cycle.

20. The method of claim 1, further comprising:
iii) sequestering the released carbon dioxide.
